(19) United States
(12) Patent Application Publication
(10) Pub. No.: US 2005/0141537 A1
(43) Pub. Date: Jun. 30, 2005

(54) Auto-learning of MAC addresses and lexicographic lookup of hardware database

(75) Inventors: Mukesh Kumar, Fremont, CA (US); Kavitha A. Prasad, San Jose, CA (US)

Correspondence Address: JUNG-HUA KUO;C/O PORTFOLIOIP, P. O. BOX 52050, MINNEAPOLIS, MN, 55402, US

(73) Assignee: Intel Corporation A DELAWARE CORPORATION, Santa Clara, CA (US)

(21) Appl. No.: 10/747,332

(22) Filed: Dec. 29, 2003

(51) Int. Cl. H04L 12/28

(52) U.S. Cl. 370/429

(57) ABSTRACT

Ethernet systems and methods for auto-learning of MAC addresses and lexicographic lookup of hardware databases are disclosed. An Ethernet network device generally includes a hardware MAC address database containing MAC address entries and a hardware MAC address learning engine in communication with the hardware MAC address database and configured to receive an unresolved source MAC address to be learned and to record the unresolved source MAC address in the hardware MAC address database in a corresponding MAC address entry. The Ethernet network device may also include a hardware lexicographic lookup engine configured to perform hardware lookups of MAC address entries in the hardware MAC address database and to interface with a management application program interface (API) for management of the Ethernet network device.

### BACKGROUND OF THE INVENTION

A network generally refers to computers and/or other device interconnected for data communication. A host computer system can be connected to a network such as a local area network (LAN) via a hardware device such as a network interface controller or card (NIC). The basic functionality of the NIC is to send and/or receive data between the host computer system and other components of the network. To the host computer, the NIC appears as an I/O device that communicates with the host bus and is controlled by the host CPU in a manner similar to the way the host CPU controls an I/O device. To the network, the NIC appears as an attached computer that can send and/or receive packets. Generally, the NIC does not directly interact with other network components and do not participate in managing of network resources and services.

A virtual LAN (VLAN) is a switched network using Data Link Layer (Layer 2) technology with similar attributes as physical LANs. VLAN is a network that is logically segmented, e.g., by department, function or application, for example. VLANs can be used to group end stations or components together even when the end stations are not physically located on the same LAN segment. VLANs thus eliminate the need to reconfigure switches when the end stations are moved.

Ethernet standards specify layer 2 addressing. Each end station connected to an Ethernet is assigned a unique MAC address configured into the physical interface hardware such as a NIC. VLANs are mapped to media access control (MAC) addresses. Traffic on VLANs is processed and forwarded by Ethernet switching devices. Ethernet uses variable-size frames each with a header and a payload. The header identifies the source MAC address, the destination MAC address and the contents of the frame or frame type. Ethernet switching devices provide filtering of frames in order to confine traffic to recipients that are members of the corresponding VLAN. VLAN membership can be statically configured by manual configuration or dynamically configured and distributed by means of GVRP (GARP (Generic Attribute Registration) VLAN Registration Protocol).

In an Ethernet switching device, MAC addresses are maintained in a MAC address table stored in hardware by a CPU sub-system of the Ethernet switching device. In addition, the CPU maintains a software copy of the MAC address table. The Ethernet switching device examines the source MAC address of all frames it receives and performs a lookup of a MAC address in the MAC address table to decide whether to forward a copy of the frame. If a frame from an unknown or unresolved source MAC address is received, the Ethernet switching device sends the frame to the CPU. Upon receiving the unknown MAC addresses, the CPU adds the MAC address into the software copy of the MAC address table and also updates the MAC address table stored in hardware.

The CPU also performs management functions on both the hardware and the CPU's software copy of the MAC address table. For example, if a MAC address or VLAN needs to be removed from the MAC address table or if any other management functions need to be performed, the CPU first performs the maintenance on the CPU's software copy of the MAC address table and then sends the update to the hardware table. As is evident, significant CPU processing power is required to maintain the CPU's software copy of the MAC address table as well as the hardware MAC address table.

### BRIEF DESCRIPTION OF THE DRAWINGS

The present invention will be readily understood by the following detailed description in conjunction with the accompanying drawings, wherein like reference numerals designate like structural elements.

FIG. 1 is a block diagram of an illustrative Ethernet processing engine of an Ethernet network device.

FIG. 2 is a block diagram showing an illustrative hardware address learning and aging module of the Ethernet processing engine of FIG. 1 in more detail.

FIG. 3 is a flowchart of an illustrative MAC address database dynamic learning process.

### DESCRIPTION OF SPECIFIC EMBODIMENTS

Ethernet systems and methods for auto-learning of MAC addresses and lexicographic lookup of hardware databases are disclosed. It should be appreciated that the present invention can be implemented in numerous ways, including as a process, an apparatus, a system, a device, a method, or a computer readable medium such as a computer readable storage medium or a computer network wherein program instructions are sent over optical or electronic communication lines. Several inventive embodiments of the present invention are described below. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

In one embodiment, an Ethernet network device generally includes a hardware MAC address database containing MAC address entries and a hardware MAC address learning engine in communication with the hardware MAC address database and configured to receive an unresolved source MAC address to be learned and to automatically record the unresolved source MAC address in the hardware MAC address database in a corresponding MAC address entry. The Ethernet network device may also include a hardware lexicographic lookup engine configured to perform hardware lookups of MAC address entries in the hardware MAC address database and to interface with a management application program interface (API) for management of the Ethernet network device. The hardware MAC address database may be contained in a pseudo content addressable memory (pCAM). The hardware MAC address learning engine may, for each MAC address entry, record in the corresponding MAC address entry: the source MAC address, a device port and a VLAN on which a corresponding frame or packet arrived at the Ethernet network device and a timestamp.

The Ethernet network device may also include a hardware aging engine in communication with the hardware MAC address database and configured to delete aging entries from the hardware MAC address database. The hardware MAC address learning engine may be further configured to delete or update a prior MAC address entry from the MAC address database when the same source MAC address is detected on a different port of the Ethernet network device from that stored in the prior MAC address entry and to automatically record the source MAC address and the different port in another or the prior MAC address entry, respectively. The hardware MAC address learning engine may also update a timestamp of a MAC address entry upon receiving a frame or packet having the same MAC address as a source MAC address.

The Ethernet network device may also include a hardware lexicographic lookup engine configured to perform hardware lookups of MAC address entries in the hardware MAC address database and to interface with a management application program interface (API) for management of the Ethernet network device.

In another embodiment, a hardware MAC address learning and aging engine generally includes an automatic hardware MAC address learning engine in communication with a MAC address database containing MAC address entries and configured to: upon receiving a source MAC address to be learned, automatically record the source MAC address to be learned in the MAC address database in a corresponding MAC address, and upon receiving a source MAC address to be updated, automatically updating a timestamp of a MAC address entry corresponding to the source MAC address to be updated; and a hardware aging engine in communication with the hardware MAC address database and configured to delete aging entries from the hardware MAC address database.

In yet another embodiment, a method for auto-learning of media access control (MAC) addresses generally includes receiving an incoming frame or packet with a source MAC address to be learned and automatically recording the source MAC address in a hardware MAC address database in a corresponding MAC address entry upon receiving the unresolved source MAC address by a hardware MAC address learning engine.

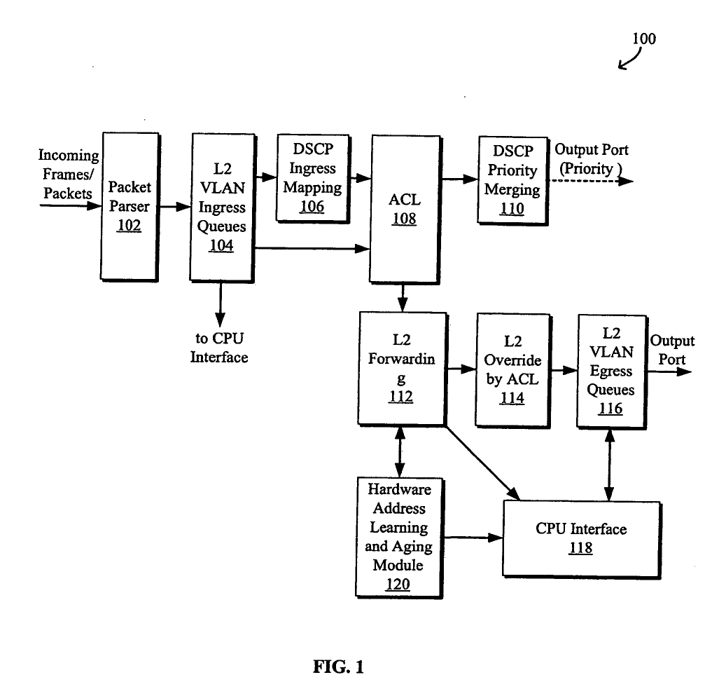

FIG. 1 is block diagram of an illustrative Ethernet processing engine 100 of an Ethernet network device. The network device may be any suitable device such as a switch, a router, and the like. In addition, the network device may be implemented with wired Ethernet, wireless Ethernet and/or various other technologies. As shown, the Ethernet processing engine 100 includes various components such as a packet parser 102, L2 VLAN ingress queues 104, a Differentiated Services Code Point (DSCP) ingress mapping module 106, an Access Control Lists (ACL) module 108, a DSCP priority merging module 110, an L2 forwarding module 112, an L2 ACL override module 114, L2 VLAN egress queues 116, a CPU interface 118 (e.g., registers), and a CPU (not shown).

The DSCP ingress mapping module 106 may classify incoming frames according to quality of service (QoS) parameters by providing tables for ingress packets that map the DSCP bits of the ingress packets to QoS levels in order to specify certain QoS treatment for ingress packets. The ACL module 108 may police and/or control the rate of traffic flows by controlling access to and/or from the network device by limiting network traffic and restricting access to certain users or devices. In particular, the ACL module 108 checks each packet for MAC (Layer 2) information to determine whether to forward a frame or to drop the frame if it cannot be forwarded based on specified routing policies, thereby providing various levels of security in a system. The DSCP priority merging module 106 may map the DSCP bits in the frames to the QoS and place the frames into the appropriate egress queues for the appropriate egress ports. For example, a packet may be marked with a DSCP value or tag corresponding to a particular per-hop behavior (PHB) given to the packet within the network. The egress queue is determined by QoS values either contained in the frame or passed along with the frame. Similar to the ingress queues, the egress queues are serviced according to importance or time criticality.

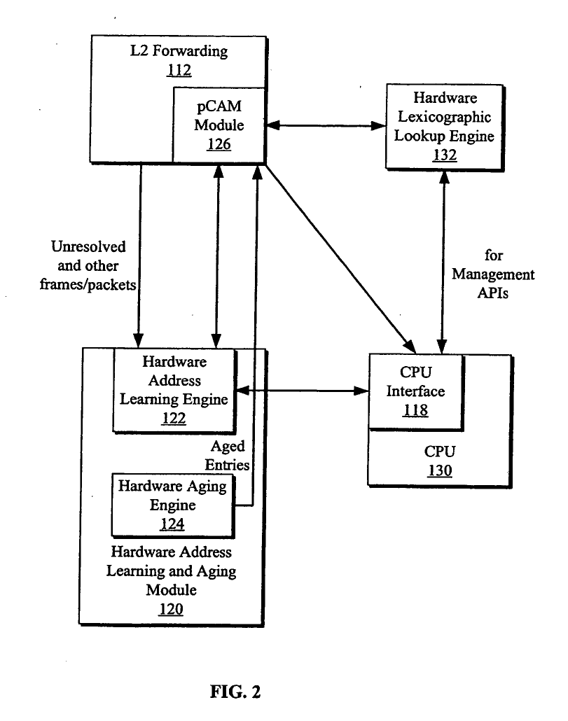

The Ethernet processing engine 100 further includes a hardware address learning and aging module 120 that communicates with the L2 forwarding module 112 and the CPU interface 118. The hardware address learning and aging module 120 is shown in more detail in the block diagram of FIG. 2. As shown, the hardware address learning and aging module 120 includes a hardware address learning engine 122 and a hardware aging engine 124.

The Ethernet processing engine 100 forwards frames or packets based on the MAC addresses contained in the frames. The process of frame forwarding involves determining what MAC addresses connect to which ports on the network device. When a frame arrives at a port on the network device, the frame is placed into one of the port's ingress queues. Each of the ingress queues contains frames to be forwarded and typically each of the ingress queues corresponds to a different priority or service level. The network device processes and forwards frames with higher priority before processing and forwarding frames with lower priority. As the ingress queues are serviced and a frame is pulled off of an ingress queue, the network device determines if, how, and where to forward the frame. Typically, the network device determines which of the egress ports the frame is to be forwarded on and also determines the forwarding policies. These determinations are preferably made simultaneously by independent components of the Ethernet processing engine 100.

The hardware address learning engine 122 maintains MAC address tables or database containing information associated with each MAC address in a content addressable memory (CAM) or pseudo CAM (pCAM) module 126 of the L2 forwarding module 112. The MAC address database enable the network device to look up many destination MAC addresses in the MAC address database for frame forwarding. The frame's destination MAC address is used as an index or key into the MAC address database. If the MAC address is found, the egress port and the appropriate VLAN ID are read from the MAC address database.

Although the MAC address database can be manually configured with the MAC address information such as for hosts whose MAC addresses that may not otherwise be learned, typically the MAC address database entries are dynamically learned by the hardware address learning engine 122. To dynamically learn information associated with a MAC address, the network device listens to incoming frames and as each frame arrives, the network device inspects the source MAC address of each frame. If the MAC address is found in the MAC address database, i.e., the source MAC address is resolved, then the network device continues processing the frame for frame forwarding. Alternatively, if the MAC address is not found in the MAC address database, i.e., the source MAC address is unresolved, the L2 forwarding module 112 forwards the frames or packets with the unresolved source MAC addresses to the hardware address learning engine 122. The hardware address learning engine 122 learns the MAC address by recording the source MAC address, the device port and the VLAN on which the frame arrived and a timestamp in the MAC address database in the pCAM module 126. The network device is generally only in a source MAC address learning mode when the spanning tree protocol (STP) algorithm has decided a port is stable for normal use.

The hardware address learning engine 122 may interface with the CPU interface 118 to, for example, maintain synchronization with the CPU 130, to communicate whether the hardware address learning engine 122 is in a learning mode, to synchronize across stack, i.e., multiple interconnected network device, etc.

On large networks, the MAC address database does not have enough space to hold every possible MAC address. To manage the CAM table space, the hardware aging engine 124 is also provided. The hardware aging engine 124 is in communication with the pCAM module 126 to age out stale entries, i.e., entries for MAC addresses that have not been heard from for a period of time. The hardware aging engine 124 ages out stale MAC address entries by causing the aged entries to be deleted from the MAC address database in the pCAM module 126. In addition, if a MAC address learned on one port has moved to a different port, the hardware address learning engine 122 preferably records the MAC address and timestamp for the most recent arrival port in the MAC address database and the previous MAC address entry is preferably deleted or allowed to be aged out. If a MAC address is already present in the MAC address table for the correct arrival port, then the hardware address learning engine 122 preferably only updates the corresponding timestamp in the pCAM module 126.

As is evident, the hardware address learning engine 122 automatically learns and stores MAC address information into the MAC address database, bypassing the CPU 130 and the CPU interface 118. The CPU thus does not need to maintain a software copy of the MAC address database nor maintain the hardware MAC address database. The automatic MAC address learning by the hardware address learning engine 122 thus reduces the load on the CPU's processing power, reduces the software complexity of the CPU, and increases the rate of MAC address learning. In addition, the hardware address learning engine 122 is preferably capable of adding MAC addresses in the MAC address database across stack, i.e., multiple interconnected network devices.

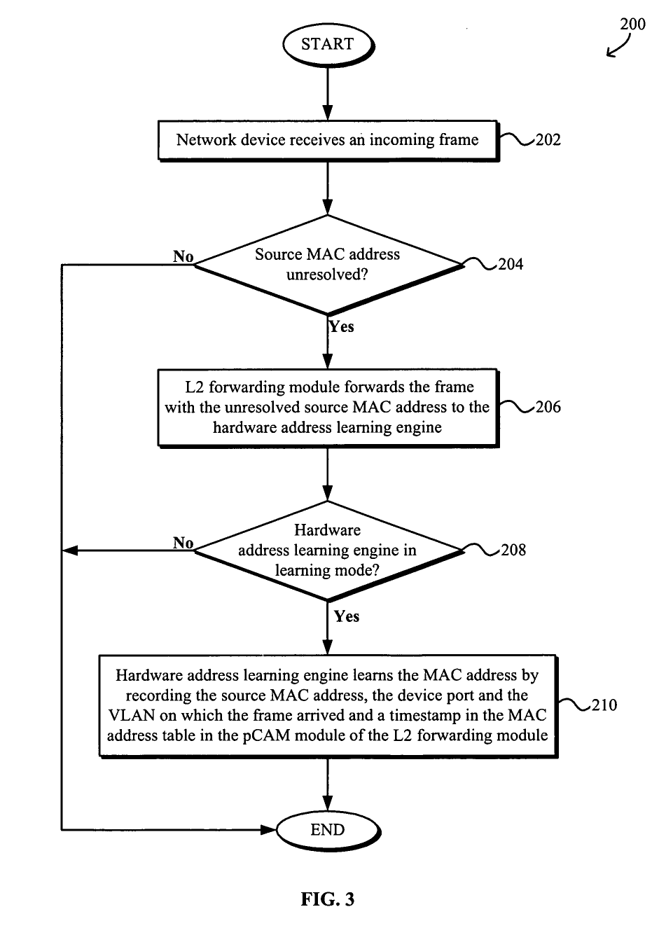

FIG. 3 is a flowchart of an illustrative MAC address database dynamic learning process 200. At block 202, the network device receives an incoming frame. At decision 204, the network device determines if the source MAC address of the received frame is resolved. If the source MAC address is resolved, then the network device continues with the frame forwarding process at block 206. Alternatively, if the source MAC address is unresolved, then the L2 forwarding module forwards the frame with the unresolved source MAC address to the hardware address learning engine at block 208. If the hardware address learning engine is in a learning mode as determined at decision 210, then the hardware address learning engine learns the MAC address by recording the source MAC address, the device port and the VLAN on which the frame arrived and a timestamp in the MAC address table in the pCAM module of the L2 forwarding module, for example, at block 212.

Referring again to FIG. 2, the Ethernet processing engine 100 preferably also includes a hardware lexicographic lookup engine 132 to provide lookup of MAC address entries in the MAC address database in the pCAM. As noted above, the MAC address is used as an index or key into the MAC address database. As is known, in lexicographic ordering, two names are lexically equal if they have identical representations while one name is lexically less than another if it is a prefix or it has a numerically lower value in the first label that differs. The hardware lexicographic lookup engine 132 facilitates lexicographic lookup of MAC address entries for management application program interfaces (APIs) to manage the network device.

As conventional network devices make softcopies of the hardware MAC address database in order to provide management API interface, the hardware lexicographic lookup engine 132 provides simpler database handling and thus an easier interface for management of the network device. In addition, the hardware lexicographic lookup engine 132 also reduces the memory requirements of the CPU for replication of the MAC address database, reduces the software complexity of the CPU, and increases the rate of MAC address lookups.

While the preferred embodiments of the present invention are described and illustrated herein, it will be appreciated that they are merely illustrative and that modifications can be made to these embodiments without departing from the spirit and scope of the invention. Thus, the invention is intended to be defined only in terms of the following claims.

1. An Ethernet network device, comprising:
a hardware media access control (MAC) address database containing MAC address entries; and
a hardware MAC address learning engine in communication with the hardware MAC address database, the hardware MAC address learning engine being configured to receive an unresolved source MAC address to be learned and to record the source MAC address to be learned in the hardware MAC address database in a corresponding MAC address entry upon receiving the unresolved source MAC address.

2. The Ethernet network device of claim 1, wherein the hardware MAC address learning engine is further configured to, for each MAC address entry, record in the corresponding MAC address entry: the source MAC address, a device port and a virtual local area network (VLAN) on which a corresponding frame or packet arrived at the Ethernet network device and a timestamp.

3. The Ethernet network device of claim 1, wherein the hardware MAC address database is contained in a pseudo content addressable memory (pCAM).

4. The Ethernet network device of claim 1, further comprising:
a hardware aging engine in communication with the hardware MAC address database, the hardware aging engine being configured to delete aging entries from the hardware MAC address database.

5. The Ethernet network device of claim 1, wherein each MAC address entry includes the MAC address and a corresponding port of the Ethernet network device on which a corresponding frame or packet arrived and wherein the hardware MAC address learning engine is further configured to one of delete and update a prior MAC address entry from the hardware MAC address database when the same source MAC address is detected on a different port of the Ethernet network device from that stored in the prior MAC address entry and to automatically record the source MAC address and the different port in one of another and the prior MAC address entry, respectively.

6. The Ethernet network device of claim 1, wherein each MAC address entry includes the MAC address and a corresponding timestamp and wherein the hardware MAC address learning engine is further configured to update a timestamp of a MAC address entry upon receiving one of a frame and packet having the same MAC address as a source MAC address.

7. The Ethernet network device of claim 1, further comprising:
a hardware lexicographic lookup engine configured to perform hardware lookup of MAC address entries in the hardware MAC address database, the hardware lexicographic lookup engine being further configured to interface with a management application program interface (API) for management of the Ethernet network device.

8. A hardware media access control (MAC) address learning and aging engine, comprising:
a hardware MAC address learning engine in communication with a MAC address database containing MAC address entries, the hardware MAC address learning engine being configured to:
upon receiving a source MAC address to be learned, record the source MAC address to be learned in the MAC address database in a corresponding MAC address, and
upon receiving a source MAC address to be updated, updating a timestamp of a MAC address entry corresponding to the source MAC address to be updated; and
a hardware aging engine in communication with the hardware MAC address database, the hardware aging engine being configured to delete aging entries from the hardware MAC address database.

9. The hardware MAC address learning and aging engine of claim 8, wherein the hardware MAC address learning engine is further configured to, for each MAC address entry, record in the corresponding MAC address entry: the source MAC address, a device port and a virtual local area network (VLAN) on which a corresponding frame or packet arrived at the Ethernet network device, and a timestamp.

10. The hardware MAC address learning and aging engine of claim 8, wherein the hardware MAC address database is contained in a pseudo content addressable memory (pCAM).

11. The hardware MAC address learning and aging engine of claim 8, wherein each MAC address entry includes the MAC address and a corresponding port of the Ethernet network device on which a corresponding frame or packet arrived and wherein the hardware MAC address learning engine is further configured to one of delete and update a prior MAC address entry from the MAC address database when the same source MAC address is detected on a different port of the Ethernet network device from that stored in the prior MAC address entry and to record the source MAC address and the different port in one of another and the prior MAC address entry, respectively.

12. The hardware MAC address learning and aging engine of claim 8, further comprising:
a hardware lexicographic lookup engine configured to lookup MAC address entries in the MAC address database, the hardware lexicographic lookup engine being further configured to interface with a management application program interface (API) for management of the Ethernet network device.

13. A method for auto-learning of media access control (MAC) addresses, comprising:
receiving an incoming frame or packet with an unresolved source MAC address to be learned;
recording the unresolved source MAC address in a hardware MAC address database in a corresponding MAC address entry upon receiving the unresolved source MAC address by a hardware MAC address learning engine.

14. The method for auto-learning of MAC addresses of claim 13, wherein the recording includes, for each MAC address entry, recording in the corresponding MAC address entry: the source MAC address, a device port and a virtual local area network (VLAN) on which a corresponding frame or packet arrived at the Ethernet network device and a timestamp.

15. The method for auto-learning of MAC addresses of claim 13, wherein the hardware MAC address database is contained in a pseudo content addressable memory (pCAM).

16. The method for auto-learning of MAC addresses of claim 13, further comprising:
deleting aging entries from the hardware MAC address database by a hardware aging engine in communication with the hardware MAC address database.

17. The method for auto-learning of MAC addresses of claim 13, wherein each MAC address entry includes the MAC address and a corresponding port of the Ethernet network device, the method further comprising:
one of deleting and updating a prior MAC address entry from the hardware MAC address database when the same source MAC address is detected on a different port of the Ethernet network device from that stored in the prior MAC address entry; and
recording the source MAC address and the different port in one of another and the prior MAC address entry, respectively.

18. The method for auto-learning of MAC addresses of claim 13, wherein each MAC address entry includes the MAC address and a corresponding timestamp, the method further comprising:
updating a timestamp of a MAC address entry by the hardware MAC address learning engine.

19. The method for auto-learning of MAC addresses of claim 13, further comprising:
performing a lexicographic lookup of a MAC address entry in the MAC address database by a hardware lexicographic lookup engine, the hardware lexicographic lookup engine interfaces with a management application program interface (API) for management of a Ethernet network device.
